(19) United States
(12) Patent Application Publication
(10) Pub. No.: US 2026/0241413 A1
(43) Pub. Date: Aug. 20, 2026

(54) PROCESS FOR PRODUCING LOW GLOSS COATING SURFACE BY RADIATION CURING

(71) Applicants: Covestro LLC, Pittsburgh, PA (US); Covestro (Netherlands) B.V., Geleen (NL)

(72) Inventors: Huimin Cao, Naperville, IL (US); Johan Franz Gradus Antonius Jansen, Geleen (NL); Michael Christopher Villet, Maastricht (NL); Erik-Jan van den Biggelaar, Raamsdonksveer (NL); Vincent van Dijk, Breda (NL); Ting-Hao Liu, Tilburg (NL)

(21) Appl. No.: 19/132,441

(22) PCT Filed: Dec. 12, 2023
(86) PCT No.: PCT/US2023/083473

§ 371 Date: May 23, 2025

Related U.S. Application Data
(60) Provisional application No. 63/432,824, filed on Dec. 15, 2022.
(60) Provisional application No. 63/432,827, filed on Dec. 15, 2022.
(60) Provisional application No. 63/432,835, filed on Dec. 15, 2022.
(60) Provisional application No. 63/432,842, filed on Dec. 15, 2022.

(51) Int. Cl. B05D 3/06

(52) U.S. Cl. CPC B05D 3/067; B05D 2503/00; B05D 2508/00

(57) ABSTRACT

The present invention relates to a method for producing a cured coating with a low gloss surface from a radiation curable coating composition, wherein the method comprises the following steps:
(1) applying a radiation curable coating composition on a substrate,
(2) irradiating the radiation curable coating composition from step (1) with UV light having wavelengths essentially in the range from 231 to 280 nm, affording a coating with a partially cured surface layer with reduced gloss,
followed by
(3) finish curing the coating from step (2) with actinic radiation, thereby fixating the partially cured surface layer with reduced gloss and affording the cured coating with the low gloss surface,
wherein step (2) and step (3) are performed in air; and
wherein the radiation curable coating composition comprises one or more acrylate functional oligomers (A) and one or more acrylate functional diluents (B).

The present invention relates to a method for producing low gloss coating surface from radiation curable coating compositions.

“Low gloss” surfaces give products a much sought-after aesthetic effect, especially in the wood-furniture, flooring and wall covering industry, because they can create a very natural appearance that contribute to giving greater emphasis to the materiality of the article. At present, the creation of matte surfaces frequently involves the use of coating products which contain matting agents made from organic and/or inorganic substances which, by positioning themselves on the coated surface and/or emerging on it, are able to act on the degree of reflection of light, giving the observer the visual sensation of a low gloss surface. However, the use of matting agents produces a worsening of the surface performance of the coating since, not being involved in the cross-linking and polymerization process, they lead to a significant reduction of resistance to chemical agents. Moreover, the incorporation of these matting agents in the formulation of the coating product significantly influences the rheology modifying the viscosity thereof to the point that it is impossible to use high concentrations of such matting agents without negatively altering the “application” characteristics of the coating product.

A particular category of surface coatings is that of radiation curable coating compositions polymerizable by e-beam or by ultraviolet radiation (UV). In general the cross-linking mechanism involves the use of actinic sources or ultraviolet radiation lamps (UV). UV lamp-induced cross-linking surface coatings may contain solvents, water and other coalescing substances in their formulation, or be characterized by a 100% solids content when their viscosity is adjusted by the addition of reactive diluents. The absence of volatile compounds such as water or volatile organic solvents results in that the applied coating thickness of coating systems having a 100% solids content only slightly reduces during the curing process. This slight shrinkage makes it more difficult to produce low gloss surfaces by the addition of conventional matting agents to the coating formulation. The Excimer lamp technology for pretreating radiation curable coating formulations with high-energy radiation in very short wavelength of ≤230 nm, preferably using 172 nm Excimer lamp, under inert gas to produce low gloss, typically deep matte coatings, is also known, as described in for example U.S. Pat. No. 9,073,082B2 and also in the review article “Low-gloss UV curable coatings: Light mechanisms, formulations and processes—A review”, from Calvez et al., Progress in Organic Coatings 171 (2022). The effect achieved by this pre-treatment with short-wave UV light is a photochemically induced micro-folding at the surface of the coating, wherein the mechanism is believed to be that a very thin skin layer of the coating, cured from the very short wavelength light, swells from the liquid underneath and forms a micro-folding structure at the surface. This micro-folding is responsible for the low gloss or matte surface. The very short wavelength of Excimer light at 230 nm penetrates into very thin skin layer and directly break C═C or C═O double bonds undergoing photoinitiator free initiation with its high photon energy. Full curing of the coating composition below the folded surface then takes place with conventional UV emitters such as for example mercury medium-pressure emitters or electron beam emitters.

A disadvantage of pre-treating radiation curable coating formulations with excimer radiation is that this must be performed under an inert gas atmosphere, such as for example under nitrogen, and hence an inert gas curing equipment is required. Nitrogen or other inert gases, like argon, are expensive. In addition, making an industrial curing line completely airtight is a challenge and thus nitrogen losses to the environment around the curing line may occur, making the process even more expensive and potentially impacting worker safety as this can lead to excessive nitrogen concentration in the environment around the curing line.

The object of the present invention is to provide a method for producing low gloss coating surface by radiation of a radiation curable coating composition without having to use matting agents and without having to use an inert gas atmosphere in the radiation process.

According to the invention, there is provided a method for producing a cured coating with a low gloss surface from a radiation curable coating composition, wherein the method comprises the following steps:
(1) applying a radiation curable coating composition on a substrate,
(2) irradiating the radiation curable coating composition from step (1) with UV light having wavelengths essentially in the wavelength range from 231 to 280 nm, affording a coating with a partially cured surface layer with reduced gloss, followed by
(3) finish curing the coating from step (2) with actinic radiation, thereby fixating the partially cured surface layer with reduced gloss and affording the cured coating with the low gloss surface,

wherein step (2) and (3) are performed in air; and

wherein the radiation curable coating composition comprises one or more acrylate functional oligomers (A) and one or more acrylate functional diluents (B).

It has surprisingly been found that the process of the present invention allows to produce low gloss coating surface without having to use an inert gas curing equipment in the UV radiation process. Another advantage of the process of the present invention is that it allows to produce low gloss coating surface without having to use matting agents, and thus without negatively affecting the stain resistance of the coating.

In the excimer lamp technology as described in for example U.S. Pat. No. 9,073,082B2, the very short wavelength≤230 nm light is the reason for the need of using inert gas to avoid strong O₂ absorption in air. However, this very short wavelength with very thin penetration depth is also believed to be responsible for producing the micro-folding surface structure resulting in matt coating surface. DE 10 2017 008353 B3 describes a method for adjusting the amplitude and frequency of microfolding during the photochemical matting of radiation-curable coatings, in which the coating is irradiated with short-wave, monochromatic radiation from a low-pressure mercury lamp with emission lines at 185 and 254 nm to increase the viscosity only on the surface of the coating, after which the coating is microstructured using an excimer emitter under an inert gas atmosphere with emission lines in the range of 172 to 222 nm, after which the microstructured coating is cured by means of UV or electron beam curing. Surprisingly the inventors discovered a method to produce low gloss coating surface by UV radiation of a radiation curable coating composition without having to use an inert gas atmosphere in the UV radiation process, wherein the step of generating the low gloss surface is through formation of micro-folding surface structure under atmospheric conditions by using UV light essentially having wavelength higher than 230 nm and lower than or equal to 280 nm, such lamp type typically used for disinfection and germicidal purpose.

For all upper and/or lower boundaries of any range given herein, the boundary value is included in the range given, unless specifically indicated otherwise. Thus, when saying from x to y, means including x and y and also all intermediate values.

The method of the present invention optionally includes an additional radiation curing step prior to step (2), i.e. prior to the step of irradiating with UV light essentially having wavelengths higher than 230 nm and lower than or equal to 280 nm. In this additional radiation curing step, the radiation curable coating composition from step (1) is pre-cured by irradiating with light with a radiation dose which results in partial curing of the coating composition from step (1) to a pre-gel or near gel point state. Accordingly, the method of the invention comprises the following steps:
(1) applying a radiation curable coating composition on a substrate,
(1b) optionally pre-curing the radiation curable coating composition from step (1) by irradiating with light, affording a partially cured coating,
(2) irradiating the radiation curable coating composition from step (1) or the partially cured coating from step (1b), when present, with UV light having wavelengths essentially in the range from 231 to 280 nm, affording a coating with a partially cured surface layer with reduced gloss,
followed by
(3) finish curing the coating from step (2) with actinic radiation, thereby fixating the partially cured surface layer with reduced gloss and affording the cured coating with the low gloss surface,
wherein step (2) and step (3) are performed in air.

In step (1) of the method of the invention, the radiation curable coating composition is applied to a substrate by methods known to the person skilled in the art, such as for example knife coating, brushing, roller coating, spraying. The coating composition is applied to the substrate in a coating thickness of preferably from 5 to 300 micron, more preferably from 15 to 175 micron, more preferably from 20 to 150 micron, more preferably from 20 to 125 micron.

The skin cure step (2) of the method of the invention is performed by irradiating the radiation curable coating composition from step (1) or the partially cured coating from step (1b) (when present) with UV light having wavelengths essentially in the range of from 231 to 280 nm, affording a coating with a partially cured surface layer with reduced gloss. The expression “UV light having wavelengths essentially in the wavelength range from X to Y (such as from 231 to 280 nm)” means that at least 60%, preferably at least 70% of the actinic radiation power of the applied radiation source is in the wavelength range of from X to Y (such as from 231 to 280 nm). As oxygen absorbs at wavelengths≤230 nm leading to the formation of ozone, it is in the present invention preferred that emissions at wavelengths≤230 nm are minimized (i.e. preferably at most 10%, more preferably at most 5%, even more preferably at most 2% and even more preferably at most 1% of the radiation power of the applied radiation source in step (2) emits light at wavelengths≤230 nm) or more preferred are even absent. Therefore preferably also of the radiation power of the applied radiation source that is emitted in the wavelength range from 200 to 390 nm, at least 60%, more preferably at least 70%, even more preferably at least 80% is in the wavelength range from X to Y (such as from 231 to 280 nm). More preferably also of the radiation power of the applied radiation source that is emitted in the wavelength range from 231 to 390 nm, at least 70%, more preferably at least 80%, even more preferably at least 90% is in the wavelength range from X to Y (such as from 231 to 280 nm).

The irradiating in step (2) is preferably carried out with UV light having wavelengths essentially in the range from 241 to 280 nm, more preferably in the range from 241 to 270 nm, even more preferably in the range from 244 to 265 nm, or preferably in the range from 251 to 280 nm, more preferably in the range from 251 to 260 nm.

The UV light applied in step (2) preferably has a UV radiation dose in the range from 2 to 200 mJ/cm², preferably has a radiation dose of at least 3 mJ/cm², or of at least 4 mJ/cm², or of at least 5 mJ/cm², and preferably has a radiation dose of at most 90 mJ/cm², preferably of at most 80 mJ/cm², or of at most 70 mJ/cm², or of at most 60 mJ/cm², or of at most 50 mJ/cm², or of at most 40 mJ/cm².

Suitable radiation sources for emitting light in a specified wavelength range can be selected by calculating the % of light emitted at the specified wavelength region from the spectral profile of the radiation source which can be obtained from the radiation source suppliers. The spectral irradiance can be expressed as irradiated power in W/nm or W/10 nm, or as spectral irradiance in W/m²/nm, or in relative scale. The spectral profile is a representation of how radiated output is distributed across the electromagnetic spectrum.

Suitable radiation sources for emitting UV light essentially in the specified wavelength range in step (2) of the method of the invention are for example low pressure mercury vapor lamps, or UVC LED lamps with peak wavelength in the range from 231 to 280 nm, for example with peak wavelength of 240 nm, or of 245 nm, or of 250 nm, or of 255 nm, or of 260 nm, or of 265 nm, or of 270 nm or of 275 nm, or Excimer lamps with peak wavelength in the range of from 231 to 280 nm, for example 248 nm (KrF*), or 253 nm (XeI*) or 259 nm (Cl₂*). For example, a suitable low pressure mercury vapor lamp that can be used in step (2) of the present invention is the BlueLight® Premium P2035 UV Disinfection Lamp System, obtainable from Heraeus Noblelight, having a dominant narrow emission peak at 254 nm with Full Width Half Maximum of 2 nm; it can be calculated from the spectral profile that in the wavelength range of from 200 to 390 nm, 91% of the irradiated power is emitted in the wavelength range of from 231 nm to 280 nm, more specifically from 251 to 260 nm. Another suitable radiation source for emitting UV light in the specified wavelength range in step (2) is a medium pressure mercury vapor lamp used in combination with an optical bandpass filter with maximum transmission in the wavelength range of from 241 nm to 270 nm, preferably with an optical bandpass filter with maximum transmission in the wavelength range of from 251 to 260 nm, for example an optical bandpass filter with maximum transmission at 254 nm. A suitable bandpass filter is for example 254 nm, 10 nm FWHM, First Surface UV bandpass filter from Edmund Optics Ltd. Suitable medium pressure mercury vapor lamps to be used in combination with such an optical bandpass filter are for example Fusion H lamps and Fusion H+ lamps, obtainable from Heraeus Noblelight. By multiplying the spectral profile of the Fusion H Bulb or of the H+ Bulb provided by the lamp supplier by the % transmission spectrum of the band pass filter provided by the filter supplier, it can be calculated that 100% of the the UV irradiated power is emitted in the wavelength range of from 231 nm to 280 nm when the Fusion H Bulb or H+ Bulb is used with this filter.

The skin cure step (2) is preferably performed with at most 6 lamps. Accordingly, the skin cure step (2) is preferably performed with 1 lamp, or with 2 lamps, or with 3 lamps, or with 4 lamps, or with 5 lamps, or with 6 lamps. Preferably each lamp has the width to cover entire width of the substrate, to form uniform gloss across entire surface. These lamps can be in one or multiple lamp units. Different lamp units can be set so that irradiance from individual lamp unit may vary, for example, earlier lamp unit(s) is (are) set at lower irradiance to form a fine multifold pattern, and later lamp unit(s) with further skin cure grows the magnitude higher to further lower the gloss. The skilled man appreciates that when using multiple lamps the surface texture, i.e. the gloss, can be further tuned by varying the distance and irradiance of the different lamps.

Preferably, the irradiance from each lamp unit in the skin cure step (2) is at least 5 mW/cm², more preferably at least 10 mW/cm², even more preferably at least 15 mW/cm², even more preferably at least 20 mW/cm², even more preferably at least 25 mW/cm², even more preferably at least 30 mW/cm²; and the irradiance from each lamp unit in the skin cure step (2) is preferably at most 500 mW/cm², more preferably at most 300 mW/cm², even more preferably at most 200 mW/cm².

The irradiating in the skin cure step (2) takes place under atmospheric conditions, i.e. in air, in other words not under inert gas conditions and/or not in an oxygen-reduced atmosphere.

A surface wrinkle pattern is formed at the coating surface after step (2). Without wishing to be bound by any theory, the surface wrinkle pattern is believed to be formed from microfolding of the coating skin layer, which microfold pattern preferably having a random microscopic pattern of peaks and valleys with average spacing between adjacent peaks and/or valleys shorter than 100 μm. By varying the radiation dose in step (2) and/or in the optional step (1 b), the microfold pattern, for example the spacing between the adjacent peaks and/or valleys, can be further tuned and it is believed that by doing so, the gloss level and/or surface texture can be further tuned.

The step (3) of the method of the invention is performed by irradiating the partially cured surface layer with actinic radiation for finish curing of the coating, thereby affording the cured coating with the low gloss surface. Curing of coatings by actinic radiation, such as for example UV light or electron beam radiation is known in the industry. Actinic radiation is understood to be electromagnetic, ionizing radiation, in particular electron beams, UV light and visible light. The irradiating in step (3) is preferably carried out with E-beam or with UV light having substantial emission at wavelengths>280 nm. More preferably, the irradiating in step (3) is carried out with UV light of which at least 40% of the actinic radiation power of the applied radiation source is provided by UV light having wavelengths higher than 280 nm. Preferably also of the radiation power of the applied radiation source that is emitted in the wavelength range from 200 to 390 nm, at least 40% is emitted at wavelengths>280 nm; and preferably also of the radiation power of the applied radiation source that is emitted in the wavelength range from 231 to 390 nm, at least 40%, more preferably at least 50% is emitted at wavelengths>280 nm.

The light applied in step (3) preferably has a radiation dose from 150 to 2500 mJ/cm², more preferably has a radiation dose of at least 200 mJ/cm², or of at least 250 mJ/cm², or at least 300 mJ/cm². The upper limit of the radiation dose in step (3) is not critical, but is usually at most 2250 mJ/cm², or of at most 2000 mJ/cm².

Suitable radiation sources for step (3) are for example LED lamps with peak wavelength in the range from 350 to 450 nm or broad band UV lamps such as medium pressure mercury vapor lamp. Preferably the irradiating in the finish curing step (3) is carried out with UV light emitted from a broad band UV lamp. Examples of suitable broad band UV lamps for step (3) are medium pressure mercury vapor arc lamps or microwave powered lamps such as for example Fusion H lamp and Fusion H+ lamp, obtainable from Heraeus Noblelight.

For example, from the spectral profile of the Fusion H Bulb 13 mm 10 Inch lamp, having a broad band light spectrum, it can be calculated that, for example in the wavelength range of from 200 to 450 nm, only 28% of the emitted light has a wavelength from 231 to 280 nm and 62% is emitted at wavelengths>280 nm. This shows the critical difference from the UV light used in step (2). For a LED lamp having a single peak at the wavelength range of from 350 nm to 450 nm, 0% of the actinic light has a wavelength of from 231 to 280 nm and 100% is emitted at wavelengths>280 nm, which shows the critical difference from the UV light used in step (2).

The irradiating in step (3) takes place under atmospheric conditions, i.e. in air, in other words not under inert gas conditions and/or not in an oxygen-reduced atmosphere.

In optional step (1b) some of the reactive ethylenically unsaturated double bonds of the curable compounds of the radiation curable coating composition polymerize in the uncured coating layer obtained in step (1), so that the coating layer partially cures to a pre-gel or near gel point state. This process is also known as pre-curing. The optional pre-curing step (1b) is preferably performed by irradiating the radiation curable coating composition from step (1) with light having substantial emission at wavelengths>280 nm. More preferably, the irradiating in step (1 b) is carried out with light of which at least 40% of the actinic radiation power of the applied radiation source is provided by light having wavelengths higher than 280 nm. More preferably, the optional pre-curing step (1b) is preferably performed by irradiating the radiation curable coating composition from step (1) with light having substantial emission at wavelengths>320 nm. Even more preferably, the irradiating in step (1b) is carried out with UV light of which at least 40%, more preferably at least 50%, even more preferably at least 60%, even more preferably at least 80% and even more preferably 100% of the actinic radiation power of the applied radiation source is provided by light having wavelengths higher than 320 nm.

The light applied in step (1b), when present, preferably has a radiation dose in the range from 1 to 200 mJ/cm², preferably has a radiation dose of at least 2 mJ/cm², or of at least 3 mJ/cm², and preferably has a radiation dose of at most 90 mJ/cm², or of at most 80 mJ/cm², or of at most 70 mJ/cm², or of at most 60 mJ/cm², or of at most 50 mJ/cm², or of at most 40 mJ/cm², or of at most 30 mJ/cm², or of at most 20 mJ/cm².

Suitable radiation sources for step (1b) are for example broad band UV lamps such as medium pressure mercury vapor lamp or LED lamps with peak wavelength in the range from 350 to 400 nm. Suitable medium pressure mercury vapor lamps are for example arc lamps or microwave powered lamps such as Fusion H lamps and Fusion H+ lamps, obtainable from Heraeus Noblelight. Preferably the irradiating in step (1b) is carried out with light emitted from a LED lamp with peak wavelength higher than 320 nm, such as for example a peak wavelength of 350 nm, or of 355 nm, or of 360 nm, or of 365 nm, or of 370 nm, or of 375 nm, or of 380 nm, or of 385 nm, or of 390 nm, or of 395 nm.

The irradiating in the optional pre-curing step (1b) preferably takes place under atmospheric conditions, i.e. in air, in other words not under inert gas conditions and/or not in an oxygen-reduced atmosphere.

The method of the present invention preferably takes place under atmospheric conditions, i.e. in air.

The skilled person will appreciate that that for the optional pre-cure step (1b), in which only a pre-gel or near gel point state of the coating should be achieved, preferably light having substantial emission higher than 350 nm, is used in the pre-cure step (1b) such as suitable LED lamps with peak wavelength higher than 350 nm, whereas for the through-cure step (3) preferably UV light having substantial emission in the wavelength range of from 281 to 390 nm is preferred such as broad band medium pressure mercury vapor lamps. This again exemplifies the differences in lamps best suited for the various steps.

The radiation doses as defined herein are the radiation doses of the light emitted in the wavelength range from 200 to 390 nm.

The method of the present invention allows to obtain surface coatings with a low gloss, whereby the gloss level can be controlled by adjusting dose condition in step (2) and/or in the optional step 1(b). The gloss of the surface of the cured coating measured at 60° geometry of angle is less than or equal to 52 gloss units, preferably is in the range from 1 to 50 gloss units, or from 4 to 40 gloss units, or from 4 to 30 gloss units, or from 4 to 20 gloss units, or from 4 to 10 gloss units; and/or the gloss of the surface of the cured coating measured at 85° geometry of angle is less than or equal to 60 gloss units, preferably is in the range from 1 to 60 gloss units, or from 5 to 40 gloss units, or from 5 to 30 gloss units.

The coating composition used in the process of the invention is radiation curable. By radiation curable is meant that radiation is required to initiate crosslinking of the composition. The coating composition used in the process of the invention contains ethylenically unsaturated (C═C) bond functionality which under the influence of irradiation, preferably in combination with the presence of a photoinitiating system, can undergo crosslinking by free radical polymerisation. The radiation curable coating composition as used in the present invention comprises (A) one or more radiation curable, acrylate functional oligomers, and (B) one or more radiation curable, acrylate functional diluents (also referred to as reactive diluents).

In an embodiment of the invention, the radiation curable coating composition used in the method of the present invention contains at least 20 wt. %, or at least 30 wt. %, or at least 40 wt. %, or at least 50 wt. % of water and non-polymerizable volatile compounds by weight of the radiation curable coating composition of the present invention. In this embodiment, the method preferably comprises a drying step prior to the skin-cure step (2). In another and preferred embodiment of the invention, the radiation curable coating composition used in the method of the present invention is 100% radiation curable. A 100% radiation curable coating composition refers to a coating composition which is substantially free of water and non-polymerizable volatile compounds. As used herein, substantially free of water and non-polymerizable volatile compounds means that the composition contains less than 20 wt. %, preferably less than 10 wt. % more preferably less than 5 wt. %, more preferably less than 3 wt. %, more preferably less than 1 wt. % of water and non-polymerizable volatile compounds by weight of the radiation curable coating composition of the present invention. A non-polymerizable volatile compound is a compound having no reactive double bonds and having an initial boiling point less than or equal to 250° C. measured at a standard atmospheric pressure of 101.3 kPa.

### Acrylate Functional Oligomers

The one or more acrylate functional oligomers (also referred to as “acrylate-functionalized oligomers) are preferably selected from the group consisting of polyether acrylate oligomers, urethane acrylate oligomers, epoxy acrylate oligomers, polyester acrylate oligomers, and any mixture thereof.

Exemplary polyester acrylate oligomers include the reaction products of acrylic acid with hydroxyl group-terminated polyester polyols. The reaction process may be conducted such that all or essentially all of the hydroxyl groups of the polyester polyol have been acrylated, particularly in cases where the polyester polyol is difunctional. The polyester polyols can be made by polycondensation reactions of polyhydroxyl functional components (in particular, diols) and polycarboxylic acid functional compounds (in particular, dicarboxylic acids and anhydrides). The polyhydroxyl functional and polycarboxylic acid functional components can each have linear aliphatic, branched aliphatic, cycloaliphatic or aromatic structures and can be used individually or as mixtures.

Examples of suitable epoxy acrylate oligomers include the reaction products of acrylic acid with an epoxy resin (polyglycidyl ether or ester). The epoxy resin may, in particular, by selected from bisphenol A diglycidyl ether, bisphenol F diglycidyl ether, bisphenol 6 diglycidyl ether, brominated bisphenol A diglycidyl ether, brominated bisphenol F diglycidyl ether, epoxy novolak resin, hydrogenated bisphenol A diglycidyl ether, hydrogenated bisphenol F diglycidyl ether, hydrogenated bisphenol S diglycidyl ether, 3,4-epoxycyclohexylmethyl 3′,4′epoxycyclohexanecarboxylate, 2-(3,4-epoxycyclohexyl-5,5-spire-3,4-epoxy)cyclohexane-1,4-dioxane, bis(3,4-epoxycyclohexylmethyl)adipate, vinylcyclohexene oxide, 4-vinylepoxycyclohexane, bis(3,4-epoxy-6-methylcyclohexylmethyl)adipate, methylenebis(3,4-epoxycyclohexane), dicyclopentadiene diepoxide, di(3,4-epoxycyclohexylmethyl) ether of ethylene glycol, ethylenebis(3, 4-epoxycyclohexanecarboxylate), 1,4-butanediol diglycidyl ether, 1,6-hexanediol diglycidyl ether, glycerol triglycidyl ether, trimethylolpropane triglycidyl ether, polyethylene glycol diglycidyl ether, polypropylene glycol diglycidyl ether, polyglycidyl ethers of a polyether polyol obtained by the addition of one or more alkylene oxides to an aliphatic polyhydric alcohol such as ethylene glycol, propylene glycol, and glycerol, diglycidyl esters of aliphatic long-chain dibasic acids, monoglycidyl ethers of aliphatic higher alcohols, monoglycidyl ethers of phenol, cresol, butyl phenol, or polyether alcohols obtained by the addition of alkylene oxide to these compounds, glycidyl esters of higher fatty acids, epoxidized soybean oil, epoxybutyistearic acid, epoxyoctyistearic acid, epoxidized linseed oil, epoxidized polybutadiene, and the like.

Suitable polyether acrylate oligomers include, but are not limited to, the condensation reaction products of acrylic acid with polyetherols which are polyether polyols (such as polyethylene glycol, polypropylene glycol or polytetramethylene glycol). Suitable polyetherols can be linear or branched substances containing ether bonds and terminal hydroxyl groups. Polyetherols can be prepared by ring opening polymerization of cyclic ethers such as tetrahydrofuran or alkylene oxides (e.g., ethylene oxide and/or propylene oxide) with a starter molecule. Suitable starter molecules include water, polyhydroxyl functional materials, polyester polyols and amines.

Urethane acrylate oligomers suitable for use in the radiation curable coating compositions of the present invention include urethanes based on aliphatic, cycloaliphatic and/or aromatic polyester polyols and/or aliphatic, cycloaliphatic and/or aromatic polyether polyols, and aliphatic, cycloaliphatic and/or aromatic diisocyanates and capped with acrylate end-groups. The polyurethane acrylate oligomers may be prepared by reacting aliphatic, cycloaliphatic and/or aromatic polyisocyanates (e.g., diisocyanate, triisocyanate) with OH group terminated polyester polyols, polyether polyols, polycarbonate polyols, polycaprolactone polyols, polyorganosiloxane polyols (e.g., polydimethylsiloxane polyols), or polydiene polyols (e.g., polybutadiene polyols), or combinations thereof to form isocyanate-functionalized oligomers which are then reacted with hydroxyl-functionalized acrylates such as hydroxyethyl acrylate or hydroxyethyl methacrylate to provide terminal acrylate groups. For example, the polyurethane acrylate oligomers may contain two, three, four or more acrylate functional groups per molecule. Other orders of addition may also be practiced to prepare the urethane acrylate oligomer, as is known in the art. For example, the hydroxyl-functionalized acrylate may be first reacted with a polyisocyanate to obtain an isocyanate-functionalized acrylate, which may then be reacted with an OH group terminated polyester polyol, polyether polyol, polycarbonate polyol, polycaprolactone polyol, polydimethysiloxane polyol, polybutadiene polyol, or a combination thereof. In yet another embodiment, a polyisocyanate may be first reacted with a polyol, including any of the aforementioned types of polyols, to obtain an isocyanate-functionalized polyol, which is thereafter reacted with a hydroxyl-functionalized acrylate to yield a polyurethane acrylate Alternatively, all the components may be combined and reacted at the same time.

Preferably, the acrylate functional oligomers are selected from the group consisting of acrylate functional urethane oligomers (also referred to as “urethane acrylate oligomers”, “polyurethane acrylate oligomers” or “carbamate acrylate oligomers”), acrylate functional epoxy oligomers (also referred to as “epoxy acrylate oligomers”), and acrylate functional polyester oligomers (also referred to as “polyester acrylate oligomers”), and mixtures thereof. More preferably, the acrylate functional oligomers are selected from the group consisting of acrylate functional urethane oligomers (also referred to as “urethane acrylate oligomers”), acrylate functional polyester oligomers (also referred to as “polyester acrylate oligomers”), and mixtures thereof.

The acrylate functional oligomers are preferably aliphatic acrylate functional oligomers, i.e. not containing aromatic groups.

Preferred urethane acrylate oligomers are aliphatic urethane acrylate oligomers. More preferred urethane acrylate oligomers are aliphatic polyester-based urethane acrylate oligomers, aliphatic polyether-based urethane acrylate oligomers, as well as aliphatic polyester/polyether-based urethane acrylate oligomers. Most preferred urethane acrylate oligomers are aliphatic polyether-based urethane acrylate oligomers.

The one or more acrylate functional oligomers preferably have an average weight per acrylate functionality (WPA), as determined using ¹H NMR as described herein, of at most 5000 g/mol, more preferably of at most 4000 g/mol, even more preferably of at most 3000 g/mol, even more preferably of at most 2000 g/mol, even more preferably of at most 1500 g/mol. The WPA of the one or more acrylate functional oligomers is preferably at least 170 g/mol, more preferably at least 180 g/mol, even more preferably at least 200 g/mol, and even more preferably at least 210 g/mol.

The WPA of the acrylate functional oligomers is determined via ¹H-NMR spectroscopy according to the method described below. More specifically, the WPA of an acrylate functional oligomer is calculated according to the following equation:

$$WPU = {[ \frac{{W}_{pyr}}{{W}_{resin}} \frac{1}{{MW}_{pyr}} \frac{{A}_{c = c} / {N}_{c = c}}{{A}_{pyr} / {N}_{pyr}} ]}^{- 1}$$

wherein,
W_{pyr} is the weight of pyrazine (internal standard),
Wᵣₑₛᵢₙ is the weight of the acrylate functional oligomer,
W_{pyr} and Wᵣₑₛᵢₙ are expressed in the same units.
MW_{pyr} is the molecular weight of the pyrazine (=80 Da) (internal standard).
A_{pyr} is the peak area for methine protons attached to the aromatic ring of pyrazine, and
N_{pyr} is the number of the methine protons of pyrazine that is equal to 4.
A_{C═C} is the peak area for methine protons ( . . . —CH═ . . . ) of the carbon-carbon double bond moiety ( . . . >C═C< . . . ) present
N_{C═C} is the number of methine protons ( . . . —CH═ . . . ) attached to the carbon-carbon double bond moiety ( . . . >C═C< . . . ) present

The peak areas of the methine protons of pyrazine and methine protons are determined as follows: a sample of 75 mg of acrylate functional oligomer is diluted at 25° C. in 1 ml deuterated chloroform containing a known amount (mg) of pyrazine as internal standard for performing ¹H-NMR spectroscopy. Subsequently, the ¹H-NMR spectrum of the acrylate functional oligomer sample is recorded at 25° C. on a 400 MHz BRUKER NMR-spectrometer. Afterwards, the chemical shifts (ppm) of the methine protons of pyrazine and the methine protons of A_{C═C} are identified. Subsequently, with the help of suitable commercially available software for analyzing ¹H-NMR spectra such as the ACD/Spectrus Processor software provided by ACD/Labs, the peak areas of the methine protons of pyrazine and of A_{C═C} are determined and these values are used in above mentioned equation to calculate the WPA.

The one or more acrylate functional oligomers preferably have an acrylate functionality of from 2 to 14, more preferably from 2 to 12, even more preferably lower than 10. The radiation curable coating composition used in the present invention may also comprise acrylate functional oligomer with a functionality of 1. The average acrylate functionality of the acrylate functional oligomers present in the radiation curable coating composition is in the range of preferably from 2 to 6. As used herein, the average acrylate functionality of the acrylate functional oligomers present in the

$$radiation curable coating composition = \overline{f} = \frac{{\sum }_{k} \frac{{w}_{k}}{{M}_{k}} {f}_{k}}{{\sum }_{k} \frac{{w}_{k}}{{M}_{k}}} ,$$

in which wₖ is the amount of acrylate functional oligomers in g present in the radiation curable coating composition with a number average molecular weight Mₖ and with an acrylate functionality fₖ.

The one or more acrylate functional oligomers preferably have a number average molecular weight Mₙ higher 1000 g/mol, more preferably higher than 1100 g/mol, more preferably higher than 1200 g/mol, even more preferably higher than 1300 g/mol and preferably lower than 10000 g/mol, more preferably lower than 7500 g/mol, even more preferably lower than 5000 g/mol, whereby the number average molecular weight Mₙ is determined determined using Triple Detection Size Exclusion Chromatography.

The one or more acrylate functional oligomers are present in the radiation curable coating composition in an amount of at least 20 wt. %, more preferably of at least 25 wt. %, more preferably of at least 30 wt. %, and preferably in an amount of of at most 80 wt. %, even more preferably of at most 75 wt. %, even more preferably of at most 70 wt. %, even more preferably of at most 65 wt. %, even more preferably of at most 60 wt. %, whereby the amounts are given relative to the total weight amount of the acrylate functional oligomers and acrylate functional diluents present in the radiation curable coating composition

### Acrylate Functional Diluents

As used herein, a “diluent” means a substance which reduces the viscosity of the greater composition into which it is added or with which it is associated.

As used herein, “reactive” means the ability to form a chemical reaction, preferably a polymerization reaction, with another molecule. As such, a reactive compound will be said to possess at least one reactive, or functional, group. It is preferred that such reactive or functional group is a polymerizable group, more preferred that such reactive or functional group is an ethylenically unsaturated polymerizable group. The acrylate group(s) of the reactive diluents are able to (co)polymerize with the acrylate groups of the acrylate functional oligomer(s).

An acrylate functional group has the following formula:

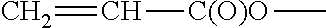

As used herein, the acrylate functionality of a compound is the number of acrylate functional groups per molecule of the compound.

The one or more acrylate functional diluents that are present in the radiation curable coating composition preferably have from 1 to 6 acrylate groups, i.e. have an acrylate functionality of from 1 to 6. More preferably, the one or more acrylate functional diluents have an acrylate functionality of from 1 to 5, even more preferably from 1 to 4. Preferably, at least one of the acrylate functional diluents that are present in the radiation curable coating composition has an acrylate functionality of 2 or 3. In a preferred embodiment, the radiation curable coating composition comprises at least two reactive diluent monomers with different functionality. The average functionality of the at least two reactive diluent monomers with different functionality is preferably at least 1.1, more preferably at least 1.2, and preferably at most 4, more preferably at most 3. As used herein, the average functionality of at least two reactive diluent monomers with different

$$functionality = \overline{f} = \frac{{\sum }_{k} \frac{{w}_{k}}{{M}_{k}} {f}_{k}}{{\sum }_{k} \frac{{w}_{k}}{{M}_{k}}} ,$$

in which wₖ is the amount of acrylate functional diluent in gram present in the radiation curable coating composition with a molar mass Mₖ and with a functionality fₖ.

Preferably, the radiation curable coating composition used in the process of the present comprises monofunctional diluent in an amount less than 50 wt. %, more preferably at less than 30 wt. %, more preferably less than 10 wt. % and more preferably less than 5 wt. %, and especially preferred less than 3 wt. %, relative to the weight of the entire radiation curable coating composition

The one or more acrylate functional diluents preferably have a molar mass higher than 125 g/mol, more preferably higher than 150 g/mol, more preferably higher than 175 g/mol, even more preferably higher than 200 g/mol and preferably lower than 800 g/mol, more preferably lower than 750 g/mol, more preferably lower than 700 g/mol, even more preferably lower than 650 g/mol. The molar mass is the calculated molar mass obtained by adding the atomic masses of all atoms present in the structural formula of the compound.

Preferably, the one or more reactive diluents are aliphatic reactive diluents, i.e. not containing aromatic groups. Preferred examples of acrylate functional diluents are lauryl acrylate, isobornyl acrylate, 1,6-hexane diol diacrylate, neopentyl glycol diacrylate, isodecyl acrylate, diethyleneglycol diacrylate, dipropyleneglycol diacrylate (DPGDA), triethyleneglcyol diacrylate, tripropyleneglcyol diacrylate trimethylolpropane diacrylate, trimethylolpropane triacrylate (TMPTA), di(trimethylolpropane) triacrylate (di-TMP3A), and pentaerythritol tetra-acrylate (PET4A), di(trimethylolpropane) tetra-acrylate (di-TMPTA), glyceryl propoxy triacrylate (GPTA), pentaerythritol tri-acrylate (PET3A).

Preferably, at least one of the reactive diluents (B) has an acrylate functionality of 2 or 3. The reactive diluents (B) with an acrylate functionality of 2 are preferably selected from the group consisting of dipropyleneglycol diacrylate (DPGDA), dipropyleneglycol diacrylate comprising additional alkoxy groups, preferably propoxy groups, and any mixture thereof.

The reactive diluents (B) with an acrylate functionality of 3 are preferably selected from the group consisting of glyceryl propoxy triacrylate (GPTA), trimethylolpropane triacrylate (TMPTA), di(trimethylolpropane) tri-acrylate (di-TMP3A), pentaerythritol tri-acrylate (PET3A) and pentaerythritol tri-acrylate, including their alkoxylated versions, and any mixture thereof.

In a preferred embodiment of the invention, at least 10 wt. %, preferably at least 20 wt. %, more preferably at least 30 wt. % more preferably at least 40 wt. %, more preferably at least 50 wt. %, more preferably at least 60 wt. %, more preferably at least 70 wt. %, more preferably at least 80 wt. %, more preferably at least 90 wt. % and most preferably 100 wt. % of the acrylate functional diluents (B) is selected from the group consisting of: di(trimethylolpropane) tetra-acrylate (di-TMPTA), di(trimethylolpropane) tri-acrylate (di-TMP3A), glycerol triacrylate, pentaerythritol tetra-acrylate (PET4A), pentaerythritol tri-acrylate (PET3A), trimethylolpropane triacrylate (TMPTA), dipropyleneglycol diacrylate (DPGDA), and their alkoxylated, preferably propoxylated, versions and any mixture thereof.

The one or more acrylate functional diluents are preferably present in the radiation curable coating composition in an amount of at least 20 wt. %, more preferably of at least 25 wt. %, even more preferably of at least 30 wt. %, even more preferably of at least 35 wt. %, even more preferably of at least 40 wt. %, and preferably in an amount of at most 80 wt. %, even more preferably of at most 75 wt. %, even more preferably of at most 70 wt. %, whereby the amounts are given relative to the total weight amount of the acrylate functional oligomers and acrylate functional diluents present in the radiation curable coating composition.

The total amount of the one or more acrylate functional oligomers and of the one or more acrylate functional diluents present in the radiation curable coating composition is at least 50 wt. %, preferably at least 60 wt. %, more preferably at least 70 wt. %, relative to the entire radiation curable coating composition.

The radiation curable coating composition used in the present invention preferably comprises a photoinitiation system that comprises (i) at least one compound that comprises at least one photoredox active group (also referred to as photoredox active compound) and (ii) at least one compound that comprises at least one redox active group (also referred to as redox active compound). In an embodiment of the invention, the photoredox active group(s) and the redox active group(s) are present in the same molecule. In another and preferred embodiment, the photoredox active group(s) and the redox active group(s) are present in separate molecules. In another preferred embodiment, a part of the photoredox active groups and a part of the redox active groups are present in the same molecule and the remaining part of the photoredox active groups and the remaining part of the redox active groups are present in separate molecules.

With a photoredox active compound is meant a compound which generates an excited state after absorbing light in the 231 to 280 nm wavelength range and when in the excited state it is able to oxidize or reduce a redox active compound.

With a redox active compound is meant a compound which is able to be oxidized or reduced by the excited state of a photoredox active compound.

Without wishing to be bound by any theory, the inventors hypothesize that upon irradiation with light in the 231 to 280 nm wavelength region, a π-π* transition might take place in the photoredox active compound. This short lived excited state might now undergo a redox reaction with the redox active compound (which reaction can be described by the Rehm Weller equation) to yield one or more initiating radicals depending on the photoredox active compound and the redox active compound. Due to the low penetration depth of light in the 231 to 280 nm wavelength region, these radicals will only be formed at the surface leading to a partially cured thin skin and subsequently diffusion of monomers into the thin skin generating micro-folding resulting in the lowering of the gloss. For the finish cure step (3) or the optional pre-cure step (1b), in which the irradiating is performed with light having substantial emission at wavelengths>280 nm, it is speculated that now a n-π* transition might take place. These longer lived excited state might generate initiating radicals via α-cleavage reactions, hydrogen abstraction reactions and via redox reactions. Due to the higher penetration depth of the light employed, this might result in radicals formed over the entire depth of the coating resulting in at least a partial (pre-cure) or full cure of the coating. In case of finish cure via E beam, initiating radicals are generated by the interaction of the accelerated electrons with the material over the entire depth of the coating.

The one or more photoredox active compounds preferably have a peak absorbance in the wavelength range from 231 to 280 nm, more preferably in the wavelength range from 241 to 280 nm, even more preferably in the wavelength range from 241 to 270 nm, even more preferably in the wavelength range from 244 to 265 nm, or preferably in the wavelength range from 251 to 280 nm, more preferably in the range from 251 to 260 nm. Examples of suitable photoredox active compounds are onium salts, like for example iodonium and sulphonium salts; and/or organometallic compounds like metallocene compounds, for example titanocene compounds; and/or compounds comprising at least one aryl ketone moiety, such as aromatic ketones and/or aromatic α-hydroxyketones; and/or keto esters. Preferred photoredox active compounds are compounds comprising at least one (preferably one or two) aryl ketone moiety with the following structural formula (1), whereby the aromatic ring may be optionally substituted with one or more C1-C9 hydrocarbon groups (preferably C1-C9 alkyl groups), one or more halogenide, one or more ether groups and/or one or more ester groups.

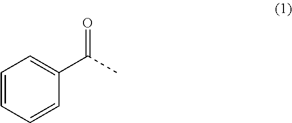

In the embodiments of the invention in which at least part of the photoredox active groups and at least part of the redox active groups are present in the same molecule, the aryl ketone moiety is for example substituted with a thioether or a dialkylamino group, for example (H₃C)₂—N—.

More preferred photoredox active compounds are aromatic ketones and aromatic α-hydroxy ketones since these with strong absorption at π-π* transition facilitate obtaining very thin skin layer easily forming microfold giving very low gloss levels. Examples of (substituted) aromatic ketones are benzophenone, methyl 2-benzoyl benzoate (CAS No 606-28-0), 4-methyl benzophenone (CAS No 134-84-9). Examples of aromatic α-hydroxy ketones are Omnirad 1173 (CAS No. 7473-98-5) and Omnirad 127 (CAS No 474510-57-1).

Suitable redox active compounds are preferably selected from the group consisting of aliphatic amines, aromatic amines, thioethers, thiols and any mixture thereof. For reasons of stability, the amine is preferably a tertiary amine as otherwise they can undergo Michael addition reactions with the radiation curable groups present in the radiation curable coating composition thereby forming a tertiary amine. More preferably, the one or more redox active compounds are aliphatic tertiary amines. Preferably, the redox active compound is acrylate functional, i.e. contains one, preferably two or more acrylate groups. Without wishing to be bound by any theory, the inventors speculate that upon reaction of the acrylate groups of the acrylate functional redox active compound in the skin layer of the coating, diffusion of this compound from the lower layers takes places, thereby enhancing the active concentration of redox active compound in the skin. Examples of suitable acrylate functional amines are Agisyn™ 002 (acrylate functionality is 1), Agisyn™ 008 (acrylate functionality is 2), both can also act as reactive diluents, Agisyn™ 701 and Agisyn™ 703 (acrylate functionality is 4), both can also act as acrylate functional oligomers, available from Covestro AG. Examples of suitable acrylate functional thioethers are BDT-1006, BDT-1015, BDT-4330 and XDT-1018, available from Bomar. Acrylate functionality of the redox active compound is believed to benefit the surface properties of the final cured coating, such as stain resistance and abrasion resistance. Most preferred redox active compounds are aliphatic tertiary amines having at least one acrylate functional group, preferably two or more acrylate functional groups.

When UV irradiation is applied in the finish-cure step (3), the photoinitiation system optionally further comprises next to the photoredox active compound another photoactive compound. With a photoactive compound is meant a compound which upon irradiation with light substantially having wavelengths>280 nm is able to generate radicals.

Examples of suitable photoactive compounds, including examples of suitable photoredox active compounds, include, but are not limited to, bisacylphosphine oxides, such as for example bis(2,4,6-trimethylbenzoyl-phenylphosphine oxide (CAS #162881-26-7) or is bis(2,4,6-trimethylbenzoy)-(2,4-bis-pentyloxypheny)phosphine oxide; monoacylphosphine oxide, such as for example 2,4,6-trimethylbenzoylethoxyphenylphosphine oxide (CAS #84434-11-7) or 2,4,6-trimethylbenzoyldiphenylphosphine oxide (CAS #127090-72-6); ketals such as 2,2-dimethoxy-1,2-diphenylethan-1-one (CAS #24650-42-8); benzophenones such as benzophenone, 2,4,6-trimethybenzophenone, 4-methylbenzophenone, 2-methylbenzophenone, 2-methoxycarbonylbenzophenone, 4-phenylbenzophenone, 4,4′-bis(dimethylamino)-benzophenone, 4,4′-bis(diethylamino)benzophenone, methyl2-benzoylbenzoate, 3,3′-dimethyl-4-methoxybenzophenone, 4-(4-methylphenylthio)benzophenone, 2,4,6-trimethyl-4′-phenyl-benzophenone or 3-methyl-4′-phenyl-benzophenone; α-hydroxy ketones such as α-hydroxycyclohexyl phenyl ketone, 2-hydroxy-2-methyl-1-phenylpropanone, 2-hydroxy-2-methyl-1-(4-isopropylphenyl)propanone, 2-hydroxy-2-methyl-1-(4-dodecylphenyl)propanone, 2-Hydroxy-1-{4-[4-(2-hydroxy-2-methyl-propionyl)-benzyl]-phenyl}-2-methyl-propan-1-one and 2-hydroxy-2-methyl-1-[(2-hydroxyethoxy)phenyl]propanone; α-aminoketones, such as 2-methyl-1-[4-(methylthio)phenyl]-2-(4-morpholinyl)-1-propanone, 2-benzyl-2-(dimethylamino)-1-[4-(4-morpholinyl)phenyl]-1-butanone, 2-(4-methylbenzyl-2-(dimethylamino)-1-[4-(4-morpholinyl)phenyl]-1-butanone or 2-benzyl-2-(dimethylamino)-1-[3,4-dimethoxyphenyl]-1-butanone; ketal compounds, for example 2,2-dimethoxy-1,2-diphenyl-ethanone; and monomeric or dimeric phenylglyoxylic acid esters, such as methylphenylglyoxylic acid ester, 5,5′-oxo-di(ethyleneoxydicarbonylpheny) or 1,2-(benzoylcarboxy)ethane; oxime esters, such as those disclosed in U.S. Pat. No. 6,596,445; phenyl glyoxalates, for example those disclosed in U.S. Pat. No. 6,048,660.

In case the finish cure is performed by irradiation with light substantially having wavelengths>280 nm, it is preferred that the photoinitiation system is also capable of generating radicals when irradiated with light having wavelengths>280 nm. Preferably the photoredox active compound and the redox active compound are also capable of generating radicals when irradiated with light having wavelengths>280 nm.

The photoinitiation system is preferably present in the radiation curable coating composition in an amount of at least 5 wt. %, more preferably of at least 7.5 wt. % and even more preferably of at least 10 wt. %, and preferably in an amount of at most 45 wt. %, more preferably of at most 30 wt. % and more preferably of at most 20 wt. %, whereby the amount is given relative to the radiation curable coating composition. Preferably, the one or more photoredox active compounds and the redox active compounds are present in the radiation curable coating composition in such an amount that the ratio of the molar amount of the photoredox active groups to the molar amount of the redox active groups is from 1:4 to 4:1, more preferably from 1:3 to 3:1, even more preferably from 1:2 to 2:1. In case a photoredox active compound is used which contains more than one photoredox active groups, the molar amount of the photoredox active groups is calculated by multiplying the molar amount of the photoredox active compound that is present in the radiation curable coating composition with the number of photoredox active groups present in the photoredox active compound. Similar, in case a redox active compound is used which contains more than one redox active groups, the molar amount of the redox active groups is calculated by multiplying the molar amount of the redox active compound that is present in the radiation curable coating composition with the number of redox active groups present in the redox active compound. For example, when pentaerytritol tetra mercaptopropionate is used as redox active compound, the molar amount of the redox active groups is calculated by multiplying the molar amount of pentaerytritol tetra mercaptopropionate that is present in the radiation curable coating composition with 4, i.e. the number of thiol groups present in pentaerytritol tetra mercaptopropionate.

In the embodiment in which the photoredox active groups and the redox active groups are present in separate molecules, the one or more photoredox active compounds are preferably present in the radiation curable coating composition in an amount of at least 1 wt. %, more preferably of at least 2 wt. %, even more preferably of at least 3 wt. %, even more preferably of at least 4 wt. %, even more preferably of at least 5 wt. % and preferably in an amount of at most 15 wt. %, more preferably of at most 12 wt. %, even more preferably of at most 10 wt. %, even more preferably of at most 9 wt. %, whereby the amount is given relative to the radiation curable coating composition; and/or the one or more redox active compounds are preferably present in the radiation curable coating composition in an amount of at least 1 wt. %, more preferably of at least 2 wt. %, even more preferably of at least 3 wt. %, even more preferably of at least 4 wt. %, even more preferably of at least 5 wt. %, and preferably in an amount of at most 30 wt. %, more preferably at most 25 wt. %, even more preferably at most 20 wt. %, even more preferably at most 15 wt. %, whereby the amount is given relative to the radiation curable coating composition. In case the redox active compound is acrylate functional (and thus may also act as reactive diluent or as reactive oligomer), the upper limit of the amount of redox active compounds can be very high. For example both reactive diluent and oligomer in the radiation curable coating composition can be amine functional and thus redox active. In this case the amount of redox active compounds can be as high as 95%. As used herein, reactive diluent comprising redox active groups and oligomer comprising redox active groups are considered herein as redox active compounds. Accordingly, the amount of reactive diluent comprising redox active groups and the amount of oligomer comprising redox active groups are included in the determination of amount of redox active compounds; the amount of reactive diluent comprising redox active groups is not to be included in the determination of the amount of reactive diluent; and the amount of oligomer comprising redox active groups is not to be included in the determination of the amount of oligomer. In case the redox active compound is acrylate functional, the amount of the redox active compounds in the radiation curable coating composition is preferably also at most 30 wt. %, more preferably at most 25 wt. %, even more preferably at most 20 wt. %, even more preferably at most 15 wt. %, even more preferably at most 20 wt. %, even more preferably at most 10 wt. %.

The radiation curable coating composition usually further contain an additive compound; that is, a collection of one or more than one individual additives having one or more than one specified structure or type. Suitable additives are for example light stabilizers, such as UV absorbers and reversible free-radical scavengers (HALS), antioxidants, degassing agents, wetting agents, emulsifiers, slip additives, waxes, polymerisation inhibitors, adhesion promoters, flow control agents, film-forming agents, rheological aids such as thickeners, flame retardants, corrosion inhibitors, waxes, driers and biocides. One or more of the aforementioned additives can be employed in the coating composition used in the process of the present invention in any suitable amount and may be chosen singly or in combination of one or more of the types enumerated herein. In a preferred embodiment, the additive compound is present in an amount, relative to the entire weight of the coating composition, of from about from 0 wt. % to 20 wt. %, or from 0 wt. % to 10 wt. %, or from 0 wt. % to 5 wt. %; or from 0.01 wt. % to 20 wt. %, or from 0.01 wt. % to 10 wt. %, or from 0.01 wt. % to 5 wt. %, or from 0.1 wt. % to 2 wt. %. According to another embodiment, the additive compound is present, relative to the weight of the entire radiation curable composition, from 1 wt. % to 20 wt. %, or from 1 wt. % to 10 wt. %, or from 1 wt. % to 5 wt. %. The coating composition can also be pigmented. The coating composition then contain at least one pigment. Preferably the coating composition does not contain any pigments. The coating composition can also contain one or more inorganic fillers.

The coating composition can also contain one or more solvents. Suitable solvents are inert in respect of the functional groups present in the coating composition, from the time at which they are added to the end of the process. Examples of suitable solvents are hydrocarbons, alcohols, ketones and esters, for example toluene, xylene, isooctane, acetone, butanone, methyl isobutyl ketone, ethyl acetate, butyl acetate, tetrahydrofuran, dimethyl acetamide, dimethyl formamide. The coating composition preferably is a 100% radiation curable coating composition as defined herein below.

The coating composition can also contain matting agents which have an additional matting effect. Suitable matting agents are for example silicon dioxides. The amount of matting agents, if included, is typical in the range of from 0.1 to 10 wt. %, in particular in the range of from 0.5 to 5 wt. %, based on the total weight of the radiation curable compounds in the coating composition.

The radiation curable coating composition used in the method of the present invention is preferably 100% radiation curable. A 100% radiation curable coating composition refers to a coating composition which is substantially free of water and non-polymerizable volatile compounds. As used herein, substantially free of water and non-polymerizable volatile compounds means that the composition contains less than 20 wt. %, preferably less than 10 wt. % more preferably less than 5 wt. %, more preferably less than 3 wt. %, more preferably less than 1 wt. % of water and non-polymerizable volatile compounds by weight of the radiation curable coating composition of the present invention. A non-polymerizable volatile compound is a compound having no reactive double bonds and having an initial boiling point less than or equal to 250° C. measured at a standard atmospheric pressure of 101.3 kPa

The present invention further relates to the radiation curable coating composition as described herein above.

The present invention further relates to a low gloss coated substrate that is obtained by coating a substrate, preferably a plastic, paper or metal substrate or a substrate of a combination of any of plastic, paper and metal with the method as described herein above.

Suitable substrates for the process according to the invention are for example mineral substrates such as fiber cement board, wood, wood containing materials, paper including cardboard, textile, leather, metal, thermoplastic polymer, thermosets, ceramic, glass. Suitable thermoplastic polymers are for example polyvinylchloride PVC, polymethylmethacrylate PMMA, acrylonitrile-butadiene-styrene ABS, polycarbonate, polypropylene PP, polyethylene PE, polyamide PA and polystyrene. Suitable thermosets are for example linoleum, epoxy, melamine, novolac, polyesters and urea-formaldehyde.

The substrate is optionally pre-treated and/or optionally pre-coated. For example, thermoplastic plastic films can be treated with corona discharges before application or pre-coated with a primer. Mineral building materials are also usually provided with a primer before the coating composition is applied.

The coating obtained in the process of the invention can advantageously be used in a floor or wall covering or in automotive interior or on furniture or on window frames or on façade panels.

The invention is further defined by the set of exemplary embodiments as listed hereafter. Any one of the embodiments, aspects and preferred features or ranges as disclosed in this application may be combined in any combination, unless otherwise stated herein or if technically clearly not feasible to a skilled person.
[1] A method for producing a cured coating with a low gloss surface from a radiation curable coating composition, wherein the method comprises the following steps:
   (1) applying a radiation curable coating composition on a substrate,
   (2) irradiating the radiation curable coating composition from step (1) with UV light having wavelengths essentially in the range from 231 to 280 nm, affording a coating with a partially cured surface layer with reduced gloss,
   followed by
   (3) finish curing the coating from step (2) with actinic radiation, thereby fixating the partially cured surface layer with reduced gloss and affording the cured coating with the low gloss surface,
   wherein step (2) and step (3) are performed in air; and
   wherein the radiation curable coating composition comprises one or more acrylate functional oligomers (A) and one or more acrylate functional diluents (B).
[2] The method according to embodiment [1], wherein the irradiating in step (2) is carried out with UV light having wavelengths essentially in the range from 241 to 280 nm, preferably in the range from 241 to 270 nm, more preferably in the range from 244 to 265 nm, or in the range from 251 to 280 nm, preferably in the range from 251 to 260 nm.
[3] The method according to embodiment [1] or [2], wherein UV light having wavelengths essentially in the wavelength range from X to Y means that at least 60%, preferably at least 70%, even more preferably at least 80% of the actinic radiation power of the applied radiation source is provided by UV light in the wavelength range of from X to Y.
[4] The method according to any of the preceding embodiments, wherein the UV light applied in step (2) has a UV radiation dose in the range from 2 to 200 mJ/cm², preferably has a radiation dose of at least 3 mJ/cm², or of at least 4 mJ/cm², or of at least 5 mJ/cm², and preferably has a radiation dose at most 90 mJ/cm², preferably of at most 90 mJ/cm², more preferably of at most 80 mJ/cm², or of at most 70 mJ/cm², or of at most 60 mJ/cm², or of at most 50 mJ/cm², or of at most 40 mJ/cm².
[5] The method according to any of the preceding embodiments, wherein the skin cure step is performed with one or more lamp units, whereby the irradiance from each lamp unit in the skin cure step (2) is at least 5 mW/cm2, more preferably at least 10 mW/cm2, even more preferably at least 15 mW/cm2, even more preferably at least 20 mW/cm2, even more preferably at least 25 mW/cm2, even more preferably at least 30 mW/cm2; and the irradiance from each lamp unit in the skin cure step (2) is preferably at most 500 mW/cm2, more preferably at most 300 mW/cm2, even more preferably at most 200 mW/cm2.
[6] The method according to any of the preceding embodiments, wherein the UV light applied in step (2) is from 1 lamp, or 2 lamps, or 3 lamps, or 4 lamps, or 5 lamps, or at most 6 lamps, and these lamps can be in one or multiple lamp units.
[7] The method according to any of the preceding embodiments, wherein the irradiating in step (2) is carried out with a low pressure mercury vapor lamp, or with an UVC LED lamp with peak wavelength in the range of from 231 to 280 nm, or with an Excimer lamp with peak wavelength of from 231 to 280 nm, or with a medium pressure mercury vapor lamp in combination with an optical bandpass filter with maximum transmission in the wavelength range of from 241 nm to 270 nm, preferably in the wavelength range of from 251 to 260 nm.
[8] The method according to any of the preceding embodiments, wherein the irradiating in the finish curing step (3) is carried out with E-beam or with light having substantial emission at wavelengths higher than 280 nm, preferably with UV light of which at least 40% of the actinic radiation power of the applied radiation source is provided by light having wavelengths higher than 280 nm.
[9] The method according to any of the preceding embodiments, wherein at most 10%, more preferably at most 5%, even more preferably at most 2%, even more preferably at most 1%, even more preferably 0% of the radiation power of the applied radiation source in step (2) emits light at wavelengths≤230 nm; and/or wherein also of the radiation power of the applied radiation source in step (2) that is emitted in the wavelength range from 200 to 390 nm, at least 60%, more preferably at least 70%, even more preferably at least 80% is in the wavelength range from 231 to 280 nm, preferably in the range from 241 to 270 nm, more preferably in the range from 244 to 265 nm, or preferably in the range from 251 to 280 nm, more preferably in the range from 251 to 260 nm, and wherein preferably also of the radiation power of the applied radiation source in step (2) that is emitted in the wavelength range from 231 to 390 nm, at least 70%, more preferably at least 80%, even more preferably at least 90% is in the wavelength range from 231 to 280 nm, more preferably in the range from 241 to 270 nm, even more preferably in the range from 244 to 265 nm, or preferably in the range from 251 to 280 nm, more preferably in the range from 251 to 260 nm.
[10] The method according to any of the preceding embodiments, wherein the light applied in step (3) has a radiation dose in the range from 150 to 2500 mJ/cm², preferably has a radiation dose of at least 200 mJ/cm², or of at least 250 mJ/cm², or at least 300 mJ/cm², and preferably has a radiation dose of at most 2250 mJ/cm², or of at most 2000 mJ/cm².
[11] The method according to any of the preceding embodiments, wherein the irradiating in step (3) is carried out with a broad band UV lamp.
[12] The method according to any one of the preceding embodiments, wherein the method comprises the following steps:
   (1) applying a radiation curable coating composition on a substrate,
   (1b) optionally pre-curing the radiation curable coating composition from step (1) by irradiating with light, affording a partially cured coating,
   (2) irradiating the radiation curable coating composition from step (1) or the partially cured coating from step (1b) with UV light having wavelengths essentially in the range from 231 to 280 nm, affording a coating with a partially cured surface layer with reduced gloss,
   followed by
   (3) finish curing the coating from step (2) with actinic radiation, thereby fixating the partially cured surface layer with reduced gloss and affording the cured coating with the low gloss surface, and
   wherein step (2) and step (3) are performed in air.
[13] The method according to embodiment [12], wherein the irradiating in step (1b), when present, is carried out with light having substantial emission at wavelengths higher than 280 nm, preferably with light of which at least 40% of the actinic radiation power of the applied radiation source is provided by light having wavelengths higher than 280 nm, more preferably with light of which at least 40%, more preferably at least 60%, more preferably at least 80%, more preferably 100% of the actinic radiation power of the applied radiation source is provided by light having wavelengths higher than 320 nm.
[14] The method according to embodiment [12] or [13], wherein the light applied in step (1b), when present, has a radiation dose in the range from 1 to 200 mJ/cm², preferably has a radiation dose of at least 2 mJ/cm², or of at least 3 mJ/cm², and preferably has a radiation dose of at most 90 mJ/cm², or of at most 80 mJ/cm², or of at most 70 mJ/cm², or of at most 60 mJ/cm², or of at most 50 mJ/cm², or of at most 40 mJ/cm², or of at most 30 mJ/cm², or of at most 20 mJ/cm².
[15] The method according to any one of embodiments [12] to [14], wherein the irradiating in step (1b), when present, is carried out with a LED lamp with peak wavelength in the range from 350 to 450 nm.
[16] The method according to any one of embodiments [12] to [15], wherein step (1b), when present, is performed in air.
[17] The method according to any one of the preceding embodiments, wherein a microfold pattern is formed at the coating surface after step (2), having a random microscopic pattern of peaks and valleys with average spacing between adjacent peaks and/or or valleys shorter than 100 μm, preferably shorter than 80 μm, more preferably shorter than 60 μm.
[18] The method according to any one of the preceding embodiments, wherein the one or more acrylate functional oligomers are selected from the group consisting of polyether acrylate oligomers, polyester acrylate oligomers, epoxy acrylate oligomers, urethane acrylate oligomers and any mixture thereof.
[19] The method according to any one of the preceding embodiments, wherein the one or more acrylate functional oligomers are selected from the group consisting of polyester acrylate oligomers, urethane acrylate oligomers and any mixture thereof.
[20] The method according to any one of the preceding embodiments, wherein the one or more acrylate functional oligomers are aliphatic acrylate functional oligomers.
[21] The method according to any one of the preceding embodiments, wherein the one or more acrylate functional oligomers are aliphatic polyester acrylate oligomers or aliphatic urethane acrylate oligomers.
[22] The method according to any one of the preceding embodiments, wherein the one or more acrylate functional oligomers are aliphatic polyether-based urethane acrylate oligomers.
[23] The method according to any one of the preceding embodiments, wherein the one or more acrylate functional oligomers have a number average molecular weight Mₙ higher 1000 g/mol, more preferably higher than 1100 g/mol, more preferably higher than 1200 g/mol, even more preferably higher than 1300 g/mol and preferably lower than 10000 g/mol, more preferably lower than 7500 g/mol, even more preferably lower than 5000 g/mol, whereby the number average molecular weight Mₙ is determined as described in the description.
[24] The method according to any one of the preceding embodiments, wherein the one or more acrylate functional oligomers have an acrylate functionality of from 2 to 14, more preferably from 2 to 12, even more preferably lower than 10.
[25] The method according to any one of the preceding embodiments, wherein the average acrylate functionality of the acrylate functional oligomers present in the radiation curable coating composition is in the range of preferably from 2 to 6, wherein the average acrylate functionality of the acrylate functional oligomers present in the

$$radiation curable coating composition = \overline{f} = \frac{{\sum }_{k} \frac{{w}_{k}}{{M}_{k}} {f}_{k}}{{\sum }_{k} \frac{{w}_{k}}{{M}_{k}}} ,$$

in which wₖ is the amount of acrylate functional oligomers in g present in the radiation curable coating composition with a number average molecular weight Mₖ and with an acrylate functionality fₖ.
[26] The method according to any one of the preceding embodiments, wherein, wherein the one or more acrylate functional oligomers have an average weight per acrylate functionality (WPA) of at most 5000 g/mol, more preferably of at most 4000 g/mol, even more preferably of at most 3000 g/mol, even more preferably of at most 2000 g/mol, even more preferably of at most 1500 g/mol, and preferably of at least 170 g/mol, more preferably at least 180 g/mol, even more preferably at least 200 g/mol, and even more preferably at least 210 g/mol, whereby the WPA is determined as described in the description.
[27] The method according to any one of the preceding embodiments, wherein the one or more acrylate functional diluents have have a molar mass higher than 125 g/mol, more preferably higher than 150 g/mol, more preferably higher than 175 g/mol, even more preferably higher than 200 g/mol and preferably lower than 800 g/mol, more preferably lower than 750 g/mol, even more preferably lower than 700 g/mol, even more preferably lower than 650 g/mol.
[28] The method according to any one of the preceding embodiments, wherein the one or more acrylate functional diluents have an acrylate functionality of from 1 to 6, more preferably from 1 to 5, even more preferably from 1 to 4.
[29] The method according to any one of the preceding embodiments, wherein at least one of the acrylate functional diluents has an acrylate functionality of 2 or 3, wherein the acrylate functional diluents with acrylate functionality of 2 are preferably selected from the group consisting of dipropyleneglycol diacrylate (DPGDA), dipropyleneglycol diacrylate comprising additional alkoxy groups, preferably propoxy groups, and any mixture thereof, and the acrylate functional diluents with acrylate functionality of 3 are preferably selected from the group consisting of glyceryl propoxy triacrylate (GPTA), trimethylolpropane triacrylate (TMPTA), di(trimethylolpropane) tri-acrylate (di-TMP3A), pentaerythritol tri-acrylate (PET3A) and pentaerythritol tri-acrylate, including their alkoxylated versions, and any mixture thereof; and/or the amount of monofunctional diluent present in the radiation curable coating composition is less than 50 wt. %, more preferably at less than 30 wt. %, more preferably less than 10 wt. % and more preferably less than 5 wt. %, and especially preferred less than 3 wt. %, relative to the weight of the entire radiation curable coating composition.
[30] The method according to any one of the preceding embodiments, wherein the radiation curable coating composition comprises at least two acrylate functional diluents with different acrylate functionality, wherein the at least two acrylate functional diluents with different functionality having an average acrylate functionality of from at least 1.1, more preferably of at least 1.2, and preferably of at most 4, more preferably of at most 3.
[31] The method according to any one of the preceding embodiments, wherein the one or more acrylate functional diluent are aliphatic; and/or at least 10 wt. %, preferably at least 20 wt. %, more preferably at least 30 wt. % more preferably at least 40 wt. %, more preferably at least 50 wt. %, more preferably at least 60 wt. %, more preferably at least 70 wt. %, more preferably at least 80 wt. %, more preferably at least 90 wt. % and most preferably 100 wt. % of the acrylate functional diluents (B) is selected from the group consisting of di(trimethylolpropane) tetra-acrylate (di-TMPTA), di(trimethylolpropane) tri-acrylate (di-TMP3A), glycerol triacrylate, pentaerythritol tetra-acrylate (PET4A), pentaerythritol tri-acrylate (PET3A), trimethylolpropane triacrylate (TMPTA), dipropyleneglycol diacrylate (DPGDA), and their alkoxylated, preferably propoxylated, versions and any mixture thereof.
[32] The method according to any one of the preceding embodiments, wherein the one or more acrylate functional oligomers are aliphatic and the one or more acrylate functional diluent are aliphatic.
[33] The method according to any one of the preceding embodiments, wherein the one or more acrylate functional oligomers are present in the radiation curable coating composition in an amount of at least 20 wt. %, more preferably of at least 25 wt. %, more preferably of at least 30 wt. %, and preferably in an amount of at most 80 wt. %, even more preferably of at most 75 wt. %, even more preferably of at most 70 wt. %, even more preferably of at most 65 wt. %, even more preferably of at most 60 wt. %; and the one or more acrylate functional diluents are present in the radiation curable coating composition in an amount of at least 20 wt. %, more preferably of at least 25 wt. %, even more preferably of at least 30 wt. %, even more preferably of at least 35 wt. %, even more preferably of at least 40 wt. %, and preferably in an amount of at most 80 wt. %, even more preferably of at most 75 wt. %, even more preferably of at most 70 wt. %, whereby the amounts are given relative to the total weight amount of the acrylate functional oligomers and acrylate functional diluents present in the radiation curable coating composition.
[34] The method according to any one of the preceding embodiments, wherein the total amount of the one or more acrylate functional oligomers and of the one or more acrylate functional diluents is at least 50 wt. %, preferably at least 60 wt. %, more preferably at least 70 wt. %, relative to the entire radiation curable coating composition.
[35] The method according to any one of the preceding embodiments, wherein the radiation curable coating composition is 100% radiation curable.
[36] The method according to any one of the preceding embodiments, wherein the radiation curable coating composition comprises a photoinitiation system comprising one or more photoredox active compounds and one or more redox active compound.
[37] The method according to any embodiment [36], wherein the one or more photoredox active compounds have a peak absorbance in the wavelength range from 231 to 280 nm, preferably in the wavelength range from 241 to 280 nm, more preferably in the wavelength range from 241 to 270 nm, even more preferably in the wavelength range from 244 to 265 nm, or preferably in the wavelength range from 251 to 280 nm, more preferably in the range from 251 to 260 nm.
[38] The method according to embodiment [36], wherein the irradiating in step (2) is carried out with UV light having wavelengths essentially in the range from 244 to 265 nm and the one or more photoredox active compounds having a peak absorption in the wavelength range of from 244 to 265 nm.
[39] The method according to any one of embodiments [36] to [38], wherein the one or more photoredox active compounds comprise at least one aryl ketone moiety, whereby the aryl group of the aryl ketone moiety is optionally substituted.
[40] The method according to any of embodiments [36] to [39], wherein the one or more redox active compounds are selected from the group consisting of tertiary amines, thioethers, thiols and any mixture thereof; more preferably the one or more redox active compounds are aliphatic tertiary amines.
[41] The method according to any of embodiments [36] to [40], wherein the one or more redox active compounds comprise one or more acrylate functional groups.
[42] The method according to any of embodiments [36] to [41], wherein the one or more redox active compound is an aliphatic tertiary amine having at least one acrylate functional group, preferably two or more acrylate functional groups.
[43] The method according to any one of embodiments [36] to [42], wherein the photoinitiation system is present in the radiation curable coating composition in an amount of at least 5 wt. %, more preferably of at least 7.5 wt. % and even more preferably of at least 10 wt. % and preferably in an amount of at most 45 wt. %, more preferably of at most 40 wt. %, more preferably at most 35 wt. %, more preferably at most 30 wt. %, even more preferably at most 25 wt. %, whereby the amount is given relative to the radiation curable coating composition.
[44] The method according to any one of embodiments [36] to [43], wherein the one or more photoredox active compounds are present in the radiation curable coating composition in an amount of at least 1 wt. %, more preferably of at least 2 wt. %, even more preferably of at least 3 wt. %, even more preferably of at least 4 wt. %, even more preferably of at least 5 wt. % and in an amount of at most 15 wt. %, more preferably of at most 12 wt. %, even more preferably of at most 10 wt. %, even more preferably of at most 9 wt. %, whereby the amount is given relative to the radiation curable coating composition.
[45] The method according to any one of embodiments [36] to [44], wherein the one or more redox active compounds are present in the radiation curable coating composition in an amount of at least 1 wt. %, more preferably of at least 2 wt. %, even more preferably of at least 3 wt. %, even more preferably of at least 4 wt. %, even more preferably of at least 5 wt. % and in an amount of at most 30 wt. %, more preferably at most 25 wt. %, even more preferably at most 20 wt. %, even more preferably at most 15 wt. %, whereby the amount is given relative to the radiation curable coating composition.
[46] The method according to any one of embodiments [36] to [45], wherein the one or more photoredox active compounds and the redox active compounds are present in the radiation curable coating composition in such an amount that the ratio of the molar amount of the photoredox active groups to the molar amount of the redox active groups is from 1:4 to 4:1, more preferably from 1:3 to 3:1, even more preferably from 1:2 to 2:1.
[47] The method according to any one of the preceding embodiments, wherein the gloss of the surface of the cured coating measured at 60° geometry of angle is less than or equal to 52 gloss units, preferably is in the range from 1 to 50 gloss units, or from 4 to 40 gloss units, or from 4 to 30 gloss units, or from 4 to 20 gloss units, or from 4 to 10 gloss units; and/or the gloss of the surface of the cured coating measured at 85⁰ geometry of angle is less than or equal to 60 gloss units, preferably is in the range from 1 to 60 gloss units, or from 5 to 40 gloss units, or from 5 to 30 gloss units.
[48] The method according to any one of the embodiments [32] to [47], wherein the gloss of the surface of the cured coating measured at 60° geometry of angle is in the range from 4 to 40 gloss units, or from 4 to 30 gloss units, or from 4 to 20 gloss units, or from 4 to 10 gloss units.
[49] A radiation curable coating composition as defined in any one of the preceding embodiments.
[50] A coated substrate, wherein the coated substrate is obtained by coating a substrate, preferably a plastic, wood or metal substrate or a substrate of a combination of any of plastic, paper and metal with the method of any of embodiments [1] to [48].
[51] The coated substrate according to embodiment [50], wherein the coated substrate is used as a floor covering or as a wall covering or in automotive interior or in furniture or in window frames or in façade panels.

The present invention is now illustrated by reference to the following examples. Unless otherwise specified, all parts, percentages and ratios are on a weight basis.

### Synthesis of Aliphatic Acrylate Functional Polyester Resin (Resin 1)

### Step 1: Synthesis of Hydroxyfunctional Polyester

A reactor, equipped with a stirrer, Vigreux column with a distillation set-up, a temperature measurement device and inert gas inlet, was charged with 558.2 g diethylene glycol, 253.6 g trimethylpropane, 645.8 g adipic acid, 0.2 g butylstanoic acid and 1.4 g distearyl pentaerythritol phosphite. The reaction mixture was heated slowly under stirring to 230° C., and kept at this temperature until the distillation of water stopped. The Vigreux column was removed, the temperature reduced to 200° C. and a slowly a vacuum was applied (100 mBar) the mixture was kept under reduced pressure until the acid value reached a value below 4 mg KOH/g resin. The vacuum was relieved with nitrogen gas, and the mixture was cooled down to below 80° C. and discharged. The resulting polyester had an acid value of 2.8 mg KOH/g and an hydroxy value of 297 mg KOH/g.

### Step 2: Acrylation of the Hydroxyfunctional Polyester

A reactor equipped with a Dean Stark set-up, a temperature measurement device and (lean) air inlet was changed with 625 g OH-functional polyester, 230 g acrylic acid, 150 g methylcyclohexane, 4.9 g methanesulphonic acid, 0.65 g distearyl pentaerythritol phosphite and 2.35 g p-methoxy phenol. The reaction mixture was heated slowly to 90° C. and water was removed via azeotropic distillation process at a temperature of 90-100° C. until the acid value reached a value of below 20 mg KOH/g resin. Next the temperature was reduced to 95° C. and the solvent distilled of under reduced pressure until a solid content of >99% was reached. After relieving the vacuum 8.6 g trimethylolpropane oxetane was added and the mixture was cooled down to below 80° C. and discharged.

The resulting acrylate functional aliphatic polyester had an acid value of 11.3 mg KOH/g. In Table 1, this acrylate functional aliphatic polyester is referred to as Resin 1.

### Preparation of Coating Composition

The ingredients listed in Table 1 were added into a container in the amount as listed in Table 1 (amounts are in wt. %, based on the weight of the coating composition) and mixed thoroughly using a speedmixer (DAC 150.1 FV, Hauschield GmbH) for 2 min @3500 rpm.

TABLE 1
Coating composition F1-F6

| | Chemical Description | | | | | | |
|---|---|---|---|---|---|---|---|
| Component | (supplier) | F1 | F2 | F3 | F4 | F5 | F6 |
| NeoRad ™ U-25- | Aliphatic urethane | 59 | | | | 59 | 59 |
| 20D | acrylate oligomer diluted | | | | | | |
| | in 20% dipropylene | | | | | | |
| | glycol diacrylate | | | | | | |
| | (Covestro AG) | | | | | | |
| Agisyn ™ 230T1 | Aliphatic urethane | | 59 | | | | |
| | acrylate oligomer | | | | | | |
| | (Covestro AG) | | | | | | |
| Agisyn ™ 670T1 | Aromatic urethane | | | 59 | | | |
| | acrylate oligomer | | | | | | |
| | (Covestro AG) | | | | | | |
| Resin 1 | Aliphatic polyester | | | | 59 | | |
| | acrylate | | | | | | |
| Agisyn ™ 2833 | Dipropylene glycol | 25 | 25 | 25 | 25 | | |
| | diacrylate DPGDA | | | | | | |
| | (Covestro AG) | | | | | | |
| Agisyn ™ 2870 | Isobornylacrylate | | | | | 25 | |
| | (Covestro AG) | | | | | | |
| Agisyn ™ 2832 | 2-phenoxy ethyl acrylate | | | | | | 25 |
| | (Covestro AG) | | | | | | |
| Agisyn ™ 008 | Functionalized aliphatic | 10 | 10 | 10 | 10 | 10 | 10 |
| | tertiary amine (acrylate | | | | | | |
| | functionality = 2) | | | | | | |
| | (Covestro AG) | | | | | | |
| Omnirad BP | Benzophenone (IGM | 6 | 6 | 6 | 6 | 6 | 6 |
| | Resins B.V.) | | | | | | |

### Application of Coating Composition (Step (1))

The coating composition F1-F6 was applied on the white part of a Leneta card (2C Leneta Inc) using a 24 μm wire rod applicator (#3 K bar, RK Printcoat Instruments Ltd) unless otherwise stated. For the other thickness, i.e. 100 μm, 6 Kbar was applied.

### EXAMPLES 1-10 (CURING OF THE COATING COMPOSITION EMPLOYING A LOW PRESSURE MERCURY VAPOR LAMP) AND COMPARATIVE EXPERIMENTS C1-C3 (SEE TABLE 2)

Immediately (within 20 seconds) after application, the coating compositions were cured on a UVio curing rig with a conveyor belt equipped with multiple lamps.

The optional precure (optional step (1b)) was performed using a 395 nm LED (Heraeus Noblelight Semray® UV4003 with an intensity (at emission window) of 14 W/cm²).

The applied radiation curable coating composition or, in case a precure is applied, the irradiation of the precured radiation curable coating composition was irradiated with UV light using an Heraeus BlueLight® Premium P2035 U V Disinfection System with an intensity of 65 mW/cm² (low pressure mercury vapor lamp with dominant emission peak at 254 nm (>90%), irradiance measured by UV Power Puck® II 32 mW/cm²) (the skin cure step (step (2)).

Subsequently the skin cured coating composition was irradiated using a medium pressure mercury vapor lamp (Heraeus Noblelight LightHammer® 10 MARK Ill H bulb, 600 W/in) (step (3)).

All curing was performed in air unless otherwise stated and the irradiation doses for UV-A, UV-B and UV-C light were determined with an UV Power Puck® II (EIT Inc) where the typical EIT optic response is given as UVA (320-390 nm), UVB (280 nm-320 nm) and UVC (250-260 nm).

Examples 1-5 and Comparative Experiments C2-C3 are all with coating composition F1 with curing conditions varied. Example 1 respectively Comparative Experiment C1 was performed under the same skin cure condition, in air respectively in N₂, both achieving similar low gloss level, demonstrating that inertization is surprisingly not needed.

In the Comparative Experiments, C2 without precure and C3 with precure, respectively in comparison to Example 1 and Example 3, the skin cure step (step (2)) was performed using medium pressure mercury vapor lamp Heraeus Noblelight LightHammer® 10 MARK III H bulb, 600 W/in, of which the power has been lowered such that the UV-C dose in the Comparative Experiments is the same as in the Examples 1 and Example 3. High gloss coating with flat coating surface (i.e. no microfold structure) was resulted from using medium pressure mercury vapor lamp H bulb emitting light of which less than 50% having a wavelength from 231 to 280 nm.

Of Examples 1, 2 and 3 and of Comparative experiment C2, microscopic pictures of the cured coating have been taken.

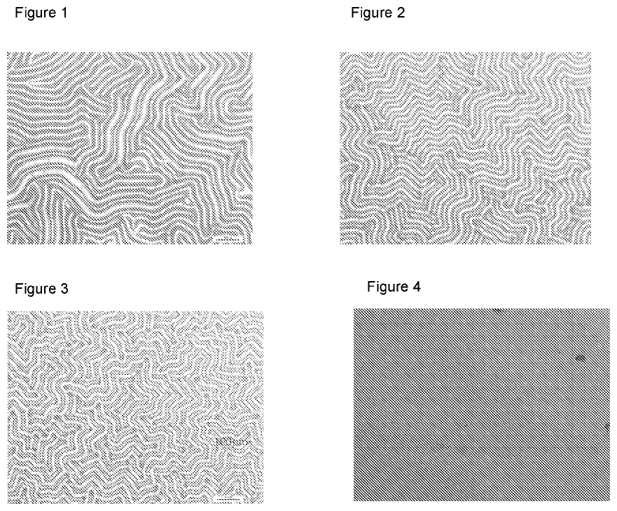

FIG. 1: Example 1

FIG. 2: Example 2

FIG. 3: Example 3

FIG. 4: Comparative experiment C2

Comparing FIG. 1 with FIG. 2 shows that the gloss values and surface texture can be tuned by varying the skin cure radiation dose. A finer microfold pattern with shorter distance between adjacent peaks or valleys is obtained in Example 2 (approximately 52 μm distance in Example 2 and approximately 60 μm distance in Example 1).

Comparing FIG. 1 with FIG. 3 shows that the gloss values and surface texture can also be tuned by performing a pre-cure (while keeping the skin cure radiation dose the same). A finer microfold pattern with shorter distance between adjacent peaks or valleys is obtained in Example 3 (approximately 34 μm distance) compared to Example 1.

FIG. 4 shows that for Comparative Experiment C2 a flat surface is obtained when the skin cure step is effected with UV light of which the minority has a wavelength in the range of from 231 to 280 nm. For Comparative experiment C3, a similar flat surface as in Comparative Experiment C1 in FIG. 4 was obtained resulting in high gloss surface.

Examples 6-8 are with coatings having different oligomers. Examples 9-10 are with coatings having different diluents. All the examples achieved gloss less than 60 at both 60° and 85°. Coatings with aliphatic oligomer and aliphatic monomer achieved 60° gloss of less than 10 and 85° gloss of less than 15 for coating composition F1, F2 and F5, 60° gloss of less than 25 and 85° gloss of less than 35 for coating composition F4; while coatings having aromatic oligomer or aromatic monomer (F3, F6) only achieved gloss level of 40-60 at both 60° and 85.

Without wishing to be bound by any theory, the inventors hypothesize that aromatic functional groups compete with photoinitiator absorption in the 231 to 280 nm wavelength region and may reduce the skin cure degree, i.e. not consuming the diluent in the skin layer sufficiently to drive the diffusion of diluent at lower layer into the thin skin resulting in multifold not as high amplitude as with aliphatic oligomers and/or diluents and therefore gloss level not as low as the coatings with aliphatic oligomers and/or diluents.

### EXAMPLE 11-12 (CURING OF THE COATING COMPOSITION EMPLOYING A BAND PASS FILTER IN THE SKIN-CURE STEP) AND COMPARATIVE EXPERIMENT C4 (SEE TABLE 3)

Immediately (within 20 seconds) after application the compositions were cured by the following steps.

The precure (step (1b)) was performed using a 395 nm LED (Phoseon RX Fireline™ 395 LED 8 W/cm2 lamp, water cooled with an AGT 1.7 kW chiller))

The precured radiation curable coating composition was irradiated with UV light essentially having wavelengths in the range of from 231 to 280 nm by using a medium pressure mercury vapor H+ lamp (600 W/in Heraeus Noblelight LightHammer® 10H+ lamp) with the light going through a bandpass filter (peak transmission at 254 nm, 10 nm Full Width Half maximum FWHM, First Surface UV bandpass filter from Edmund Optics) (the skin cure step (2)).

Subsequently the skin cured coating composition was irradiated using a medium pressure mercury vapor H+ lamp (600 W/in Heraeus Noblelight LightHammer® 10H+ lamp) (step (3)).

All curing was performed in air unless otherwise stated and the irradiation doses for UV-A, UV-B and UV-C light were determined with an UV Power Puck® II (EIT Inc) where the typical EIT optic response is given as UVA (320-390 nm), UVB (280 nm-320 nm) and UVC (250-260 nm).

Examples 11-12 achieved low gloss coating surface with 60° gloss below 15 gloss units GU and with 85° gloss ranging from very low level of from 5 to 20 GU to medium low level of from 20 to 60 GU by adjusting precure dose.

In the Comparative Experiment C4, the skin cure step (step (2)) was performed using a medium pressure mercury vapor lamp, 600 W/in Heraeus Noblelight LightHammer® 10H+ lamp, of which the power has been lowered such that the UV-C dose in the Comparative Experiment C4 is the same as in Example 11 and without employing the bandpass filter. A similar flat surface as in Comparative Experiment C1 in FIG. 4 was obtained resulting in high gloss surface.

### Testing of the Cured Coating Compositions

The gloss is determined according to ISO2813 in the direction of the drawdown and is expressed in gloss units (GU). Results are presented in Table 2 and 3.

TABLE 2
Curing of the coating composition employing a low pressure mercury
vapor lamp for the skin cure step (2) in Examples 1-10

| | | | Optional precure | Skincure | Final cure | | |
|---|---|---|---|---|---|---|---|
| | | | (Step (1b)) | (Step (2)) | (Step (3)) | | |
| | | | Dose | Dose | Dose | | |
| | Coating | Thickness | UVA/UVB/UVC | UVA/UVB/UVC | UVA/UVB/UVC | Gloss | Gloss |
| Ex | comp | μm | mJ/cm² | mJ/cm² | mJ/cm² | 60° | 85° |
| 1 | F1 | 24 | — | —/—/12 | 242/141/42 | 7 | 7 |
| C1 | F1 | 24 | — | —/—/12 (N₂) | 242/141/42 | 5 | 12 |
| 2 | F1 | 24 | — | —/—/22 | 242/141/42 | 6 | 20 |
| 3 | F1 | 24 | 6/—/— | —/—/12 | 242/141/42 | 7 | 22 |
| 4 | F1 | 24 | 16/—/— | —/—/12 | 242/141/42 | 8 | 53 |
| 5 | F1 | 100 | 6/—/— | —/—/12 | 242/141/42 | 5 | 9 |
| C2 | F1 | 24 | — | 34/27/12 | 242/141/42 | >85 | >90 |
| C3 | F1 | 24 | 6/—/— | 34/27/12 | 242/141/42 | >85 | >90 |
| 6 | F2 | 24 | — | —/—/27 | 242/141/42 | 4 | 4 |
| 7 | F3 | 24 | — | —/—/27 | 242/141/42 | 45 | 44 |
| 8 | F4 | 24 | — | —/—/22 | 242/141/42 | 22 | 34 |
| 9 | F5 | 24 | — | —/—/22 | 242/141/42 | 8 | 12 |
| 10 | F6 | 24 | — | —/—/22 | 242/141/42 | 52 | 50 |

TABLE 3
Curing of the coating composition employing a band pass
filter for the skin cure step (2) in Examples 11-12

| | | | Optional precure | Skincure | Final cure | | |
|---|---|---|---|---|---|---|---|
| | | | (Step (1b)) | (Step (2)) | (Step (3)) | | |
| | | | Dose | Dose | Dose | | |
| | Coating | Thickness | UVA/UVB/UVC | UVA/UVB/UVC | UVA/UVB/UVC | Gloss | Gloss |
| Ex | Comp | μm | mJ/cm² | mJ/cm² | mJ/cm² | 60° | 85° |
| 11 | F1 | 24 | 5/—/— | —/—/9 | 938/524/202 | 6 | 5 |
| 12 | F1 | 24 | 14/—/— | —/—/9 | 938/524/202 | 14 | 25 |
| C4 | F1 | 24 | 5/—/— | 47/21/9 | 938/524/202 | >85 | >90 |

1. A method for producing a cured coating with a low gloss surface from a radiation curable coating composition, comprising:
(1) applying a radiation curable coating composition on a substrate,
(2) irradiating the radiation curable coating composition from step (1) with UV light having wavelengths essentially in the range from 231 to 280 nm, wherein UV light having wavelengths essentially in the wavelength range from 231 to 280 means that at least 60% of the actinic radiation power of the applied radiation source in step (2) is provided by UV light in the wavelength range of from 231 to 280 nm, affording a coating with a partially cured surface layer with reduced gloss,
followed by
(3) finish curing the coating from step (2) with actinic radiation, thereby fixating the partially cured surface layer with reduced gloss and affording the cured coating with the low gloss surface,
wherein step (2) and step (3) are performed in air; and
wherein the radiation curable coating composition comprises one or more acrylate functional oligomers (A) and one or more acrylate functional diluents (B).

2. The method according to claim 1, wherein the one or more acrylate functional oligomers are selected from the group consisting of polyether acrylate oligomers, polyester acrylate oligomers, epoxy acrylate oligomers, urethane acrylate oligomers and any mixture thereof.

3. (canceled)

4. The method according to claim 1, wherein the one or more acrylate functional oligomers are aliphatic acrylate functional oligomers.

5. The method according to claim 1, wherein the one or more acrylate functional oligomers are aliphatic polyester acrylate oligomers or aliphatic urethane acrylate oligomers.

6. The method according to claim 1, wherein the one or more acrylate functional oligomers are aliphatic polyether-based urethane acrylate oligomers.

7. The method according to claim 1, wherein the one or more acrylate functional oligomers have a number average molecular weight Mₙ higher 1000 g/mol and lower than 10000 g/mol.

8. The method according to claim 1, wherein the one or more acrylate functional oligomers have an acrylate functionality of from 2 to 14.

9. The method according to claim 1, wherein the one or more acrylate functional oligomers have an average weight per acrylate functionality (WPA) of at most 5000 g/mol and at least 170 g/mol.

10. The method according to claim 1, wherein the one or more acrylate functional diluents have a molar mass higher than 125 g/mol and lower than 800 g/mol.

11. The method according to claim 1, wherein the one or more acrylate functional diluents have an acrylate functionality of from 1 to 6.

12. The method according to claim 1, wherein at least one of the acrylate functional diluents has an acrylate functionality of 2 or 3.

13. The method according to claim 1, wherein the radiation curable coating composition comprises at least two acrylate functional diluents with different acrylate functionality, wherein the at least two acrylate functional diluents with different functionality having an average acrylate functionality of from at least 1.1 to at most 4.

14. The method according to claim 1, wherein the one or more acrylate functional diluents are aliphatic.

15. The method according to claim 1, wherein the one or more acrylate functional oligomers are aliphatic and the one or more acrylate functional diluents are aliphatic.

16. The method according to claim 1, wherein the one or more acrylate functional oligomers are present in the radiation curable coating composition in an amount of at least 20 wt. % and at most 80 wt. % and the one or more acrylate functional diluents are present in the radiation curable coating composition in an amount of at least 20 wt. % and at most 80 wt. %, relative to the total weight weight of the acrylate functional oligomers and acrylate functional diluents present in the radiation curable coating composition.

17. The method according to claim 1, wherein the total amount of the one or more acrylate functional oligomers and of the one or more acrylate functional diluents is at least 50 wt. %, relative to the entire weight of the radiation curable coating composition.

18. The method according to claim 1, wherein the radiation curable coating composition is 100% radiation curable.

19. The method according to claim 1, wherein the gloss of the surface of the cured coating measured at 60° geometry of angle is less than or equal to 52 gloss units and/or the gloss of the surface of the cured coating measured at 85° geometry of angle is less than or equal to 60 gloss units.

20. The method according to claim 1, wherein the radiation curable coating composition comprises a photoinitiating system comprising at least one absorption peak at a wavelength in the range from 231 to 280 nm.

21. The method according to claim 1, wherein UV irradiation is applied in step (3) and the radiation curable coating composition comprises a photo-initiating system comprising at least one absorption peak at a wavelength in the range from 231 to 280 nm and at least one absorption peak at a wavelength higher than 280 nm.

22-24. (canceled)
